(19) United States
(12) Patent Application Publication
(10) Pub. No.: US 2018/0179947 A1
(43) Pub. Date: Jun. 28, 2018

(54) HIGH PRESSURE ROTOR SEAL CONFIGURATION FOR SUPERCHARGER

(71) Applicant: Eaton Corporation, Cleveland, OH (US)

(72) Inventor: Matthew Henry, Kalamazoo, MI (US)

(21) Appl. No.: 15/904,289

(22) Filed: Feb. 23, 2018

Related U.S. Application Data
(63) Continuation of application No. PCT/US2016/039952, filed on Jun. 29, 2016.
(60) Provisional application No. 62/209,417, filed on Aug. 25, 2015.
(60) Provisional application No. 62/209,431, filed on Aug. 25, 2015.

(51) Int. Cl. F02B 33/36; F02B 29/04; F02B 37/10; F02B 39/14; F02M 26/05

(52) U.S. Cl. CPC F02B 33/36; F02B 29/0418; F02M 26/06; F02B 39/14; F02M 26/05; F02B 37/10

(57) ABSTRACT

A supercharger that receives and/or generates high pressure boost air and contains gear lubrication includes a housing, a rotor coupled to a rotor shaft rotatably supported in the housing, and a high pressure rotor seal disposed about the rotor shaft. The high pressure rotor seal includes a primary lip configured to contact the rotor shaft and be exposed to the gear lubrication, and at least one boost pressure blocking lip configured to contact the rotor shaft and maintain a seal against the rotor shaft when the high pressure boost air acts thereon.

### CROSS REFERENCE TO RELATED APPLICATIONS

This application is a continuation of International Application No. PCT/US2016/039952 filed Jun. 29, 2016, which claims the benefit of U.S. Patent Application Nos. 62/209,417 and 62/209,431, filed Aug. 25, 2015, the contents of which are incorporated herein by reference thereto.

### FIELD

The present disclosure relates generally to superchargers and more particularly to superchargers incorporating a high pressure rotor seal configuration.

### BACKGROUND

Energy efficient engines of reduced size are desirable for fuel economy and cost reduction. However, smaller engines provide less torque than larger engines. To increase the torque capacity available from smaller engines, boosting systems are incorporated to boost the air pressure at the engine intake to increase the torque available from the engine. Some conventional boosting systems include both a mechanically driven supercharger and an exhaust gas-driven turbocharger.

A turbocharger typically includes a turbine exposed to engine exhaust flow and a compressor positioned in the air intake of the engine. Exhaust flow from the engine turns the turbine which transfers torque to the compressor causing the compressor to boost the intake air pressure. Turbochargers can be efficient but have the disadvantage of lag, which refers to a delay in providing boost pressure. Because the turbocharger depends on energy from the exhaust to provide the boost pressure, high levels of boost are not immediately provided when the engine is operating at lower speeds. Instead, full levels of boost are not provided until the engine reaches a high enough speed where the exhaust has sufficient energy to adequately drive the turbocharger.

A supercharger is driven by torque drawn directly from the engine, which enables the supercharger to provide a rapid boost in pressure without the type of delays associated with turbochargers. However, superchargers are typically designed with a fixed gear ratio that under normal driving conditions generates excess air flow that is typically routed through a bypass and recirculated through the supercharger, which results in energy loss.

To overcome the above issues, compound boost systems have been introduced that include both turbochargers and superchargers. In this type of system, the turbocharger is typically used as the primary boost producer, and the supercharger is designed to supplement the turbocharger to compensate for lag. However, in systems where the turbocharger is located upstream of the supercharger, the turbocharger will provide an elevated inlet pressure condition to the supercharger, which elevates the pressure applied to seals in the supercharger. As such, the primary lip of the seal may be crushed or rendered ineffective, which may result in oil leakage.

Accordingly, it is desirable to provide an improved seal configuration for boosting systems that may be used in compound boosting systems.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

In one aspect, a high pressure rotor seal for a supercharger that receives and/or generates high pressure boost air and contains gear lubrication, is provided. The rotor seal includes a primary lip configured to contact a rotor shaft of the supercharger and be in contact with the gear lubrication, and at least one blocking lip configured to contact the rotor shaft of the supercharger. The at least one blocking lip is configured to maintain a seal against the rotor shaft when the high pressure boost air acts thereon.

In addition to the foregoing, the described high pressure rotor seal may include one or more of the following features: wherein the at least one blocking lip includes two blocking lips; wherein the at least one blocking lip includes three blocking lips; a backing plate disposed adjacent the primary lip, the backing plate configured to provide structural support to the primary lip and prevent the primary lip from being crushed under excessive boost pressure; wherein the backing plate is curved; wherein the curved backing plate generally follows a curvature of the primary lip; a cage, wherein the primary lip and the at least one blocking lip are at least partially secured within the cage; wherein the cage includes a first flange and a second flange, at least a portion of the primary lip and the at least one blocking lip disposed between the first and second flanges; wherein the primary lip includes a proximal portion disposed between the first and second flanges, and a distal portion extending toward the rotor shaft and a bearing cavity of the supercharger; wherein each blocking lip includes a proximal portion disposed between the first and second flanges, and a distal portion extending toward the rotor shaft and a rotor cavity of the supercharger; and a spacer disposed between the proximal portion of the primary lip and the proximal portion the at least one blocking lip, and hydrodynamic grooves formed on a first side of the primary lip, the hydrodynamic grooves configured to pump oil across the rotor seal.

In another aspect, a supercharger that receives and/or generates high pressure boost air and contains gear lubrication, is provided. The supercharger includes a housing, a rotor coupled to a rotor shaft rotatably supported in the housing, and a high pressure rotor seal disposed about the rotor shaft. The high pressure rotor seal includes a primary lip configured to contact the rotor shaft and be exposed to the gear lubrication, and at least one boost pressure blocking lip configured to contact the rotor shaft and maintain a seal against the rotor shaft when the high pressure boost air acts thereon.

In addition to the foregoing, the described supercharger may include one or more of the following features: an inlet port formed in a forward end of the housing, the inlet port configured to receive at least one of air, an air-fuel mixture, and the high pressure boost air; wherein the at least one blocking lip includes two blocking lips; wherein the at least one blocking lip includes three blocking lips; wherein the high pressure rotor seal further comprising a backing plate disposed adjacent the primary lip, the backing plate configured to provide structural support to the primary lip and prevent the primary lip from being crushed under excessive boost pressure; wherein the backing plate is curved and generally follows a curvature of the primary lip; wherein the high pressure rotor seal further comprising a cage, wherein the primary lip and the at least one blocking lip are at least partially secured within the cage; wherein the cage includes a first flange and a second flange, at least a portion of the primary lip and the at least one blocking lip disposed between the first and second flanges; and wherein the primary lip includes a proximal portion disposed between the first and second flanges, and a distal portion extending toward the rotor shaft and a bearing cavity of the supercharger, wherein each blocking lip includes a proximal portion disposed between the first and second flanges, and a distal portion extending toward the rotor shaft and a rotor cavity of the supercharger, and a spacer is disposed between the proximal portion of the primary lip and the proximal portion the at least one blocking lip.

In yet another aspect, a high pressure rotor seal for a supercharger that receives and/or generates high pressure boost air and contains gear lubrication, is provided. The rotor seal includes a seal body defining an outer surface and an inner surface, a primary lip extending from the seal body and configured to contact a rotor shaft of the supercharger and be in contact with the gear lubrication, and a rigid guide plate disposed at least partially within the seal body against the seal body inner surface. The rigid guide plate is configured to prevent the high pressure rotor seal from being crushed under the high pressure boost air.

In addition to the foregoing, the described high pressure rotor seal may include one or more of the following features: wherein the primary lip extends toward an air side of the supercharger; wherein the primary lip is curved and extend towards a bearing cavity of the supercharger; wherein the rigid guide plate comprises a generally annular rim, a first flange, and a second flange; wherein the first flange extends radially outward from the rim, and the second flange extends radially inward from the rim; wherein the second flange is curved and generally follows a curvature of the primary lip; wherein a gap is defined between an end of the second flange and the rotor shaft, the gap configured to allow the lubrication to flow to the primary lip; a rigid cage disposed at least partially within the body; wherein the primary lip includes hydrodynamic grooves formed on a first side of the primary lip, the hydrodynamic grooves configured to pump oil across the rotor seal; and wherein the rigid guide plate is pressed into an inner diameter of the body.

In yet another aspect, a supercharger that receives and/or generates high pressure boost air and contains gear lubrication, is provided. The supercharger include a housing, a rotor coupled to a rotor shaft rotatably supported in the housing, and a high pressure rotor seal disposed about the rotor shaft. The high pressure rotor seal includes a seal body defining an outer surface and an inner surface, a primary lip extending from the seal body and configured to contact the rotor shaft and be in contact with the gear lubrication, and a rigid guide plate disposed at least partially within the seal body against the seal body inner surface. The rigid guide plate is configured to prevent the high pressure rotor seal from being crushed under the high pressure boost air.

In addition to the foregoing, the described supercharger may include one or more of the following features: an inlet port formed in a forward end of the housing, the inlet port configured to receive at least one of air, an air-fuel mixture, and the high pressure boost air; wherein the housing defines a seal receiving bore defined between a rotor cavity and a bearing cavity, the high pressure rotor seal disposed in the seal receiving bore; wherein the primary lip extends toward an air side of the supercharger; wherein the primary lip is curved and extend towards a bearing cavity of the supercharger; wherein the rigid guide plate comprises a generally annular rim, a first flange, and a second flange; wherein the first flange extends radially outward from the rim, and the second flange extends radially inward from the rim; wherein the second flange is curved and generally follows a curvature of the primary lip; wherein a gap is defined between an end of the second flange and the rotor shaft, the gap configured to allow the lubrication to flow to the primary lip; and a rigid cage disposed at least partially within the body, wherein the primary lip includes hydrodynamic grooves formed on a first side of the primary lip, the hydrodynamic grooves configured to pump oil across the rotor seal, and wherein the rigid guide plate is pressed into an inner diameter of the body.

### BRIEF DESCRIPTION OF THE DRAWINGS

The present disclosure will become more fully understood from the detailed description and the accompanying drawings, wherein:

FIG. 1 is a schematic view of an example combined turbocharger and supercharger boost system in accordance with the principles of the present disclosure;

FIG. 2 is a cross sectional view of an example supercharger that may be used with the system shown in FIG. 1;

FIG. 3 is front perspective view of an example high pressure seal in accordance with the principles of the present disclosure and that may be used with the systems shown in FIGS. 1 and 2;

FIG. 4 is a rear perspective view of the high pressure seal shown in FIG. 3;

FIG. 5 is a cross sectional view of the high pressure seal shown in FIGS. 3 and 4;

FIG. 6 is another cross sectional view of the high pressure seal shown in FIGS. 3 and 4;

FIG. 7 is a cross sectional view of another example of the high pressure seal, which includes an example backing plate, in accordance with the principles of the present disclosure;

FIG. 8 is front perspective view of an example high pressure seal in accordance with the principles of the present disclosure and that may be used with the systems shown in FIGS. 1 and 2;

FIG. 9 is a rear perspective view of the high pressure seal shown in FIG. 8; and

FIG. 10 is a cross sectional view of the high pressure seal shown in FIGS. 8 and 9 and disposed in a housing about a rotor shaft.

### DETAILED DESCRIPTION

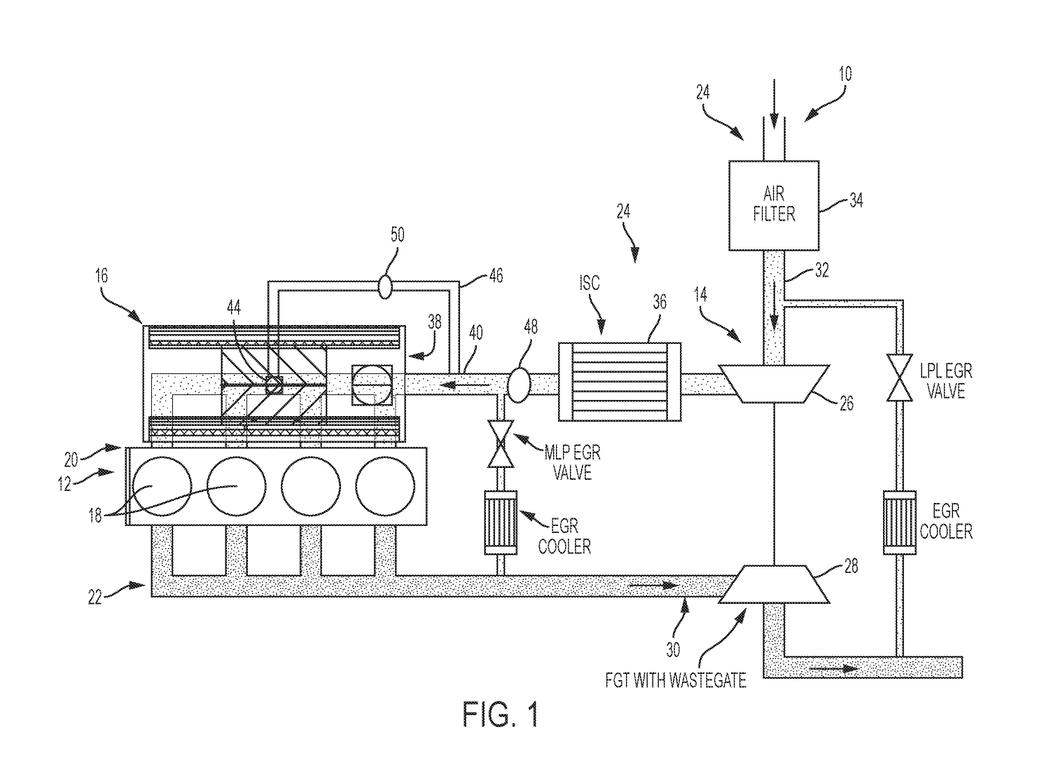

With initial reference to FIG. 1, a schematic illustration of an exemplary combined turbocharger and supercharger boost system 10 is shown. The combined boost system 10 generally includes an engine 12, a turbocharger 14, and a supercharger 16.

In the illustrated example, the engine 12 can include a plurality of cylinders 18, and an intake manifold assembly 20 and exhaust manifold assembly 22 for respectively directing combustion air to and from an engine combustion chamber (not shown).

The turbocharger 14 and the supercharger 16 can be positioned in series along an air intake 24 of the engine 12 with the supercharger 16 positioned downstream of the turbocharger 14. The turbocharger 14 generally includes a compressor portion 26 and a turbine portion 28, which can be mechanically coupled to, and operable to drive, the compressor 26. The turbine portion 28 can be disposed in an exhaust gas conduit 30, which can receive exhaust gas from the engine 12 through the exhaust manifold assembly 22. The compressor portion 26 can receive air through an intake conduit 32 having an air filter 34. The compressor portion 26 can compress the intake air and subsequently supply the compressed intake air to an intercooler 36 before it is directed to the supercharger 16.

The supercharger 16 can include an inlet port 38 which can receive air or air-fuel mixture from an inlet duct or passage 40, and can further include a discharge or outlet port 42, directing the charged air to the intake valves (not shown) via a discharge duct 44. In other embodiments, the supercharger 16 can include a front inlet design such that the inlet port is located at a forward end of the supercharger housing (e.g., opposite illustrated inlet port 38) proximate a gear case or isolator assembly or both.

The inlet duct 40 and discharge duct 44 can be interconnected by means of a bypass passage 46. If the engine 12 is of the Otto cycle type, a throttle valve 48 can control air or air-fuel mixture flowing into the inlet duct 40 from a source, such as ambient or atmospheric air, in a well know manner. Alternatively, the throttle valve 48 may be disposed downstream of the supercharger 16.

A bypass valve 50 can be disposed within the bypass passage 46 and may be moved between an open position and a closed position by an actuator assembly (not shown) or the like. The actuator assembly can be operative to control the supercharging pressure in the discharge duct 44 as a function of engine power demand. When the bypass valve 50 is in the fully open position, air pressure in the inlet duct 40 is relatively low, but when the bypass valve 50 is fully closed, the air pressure in the inlet duct 40 is relatively high. The bypass valve 50 shown and described herein is exemplary and other configurations are contemplated. In this regard, a modular (integral) bypass, an electronically operated bypass, or no bypass may be used.

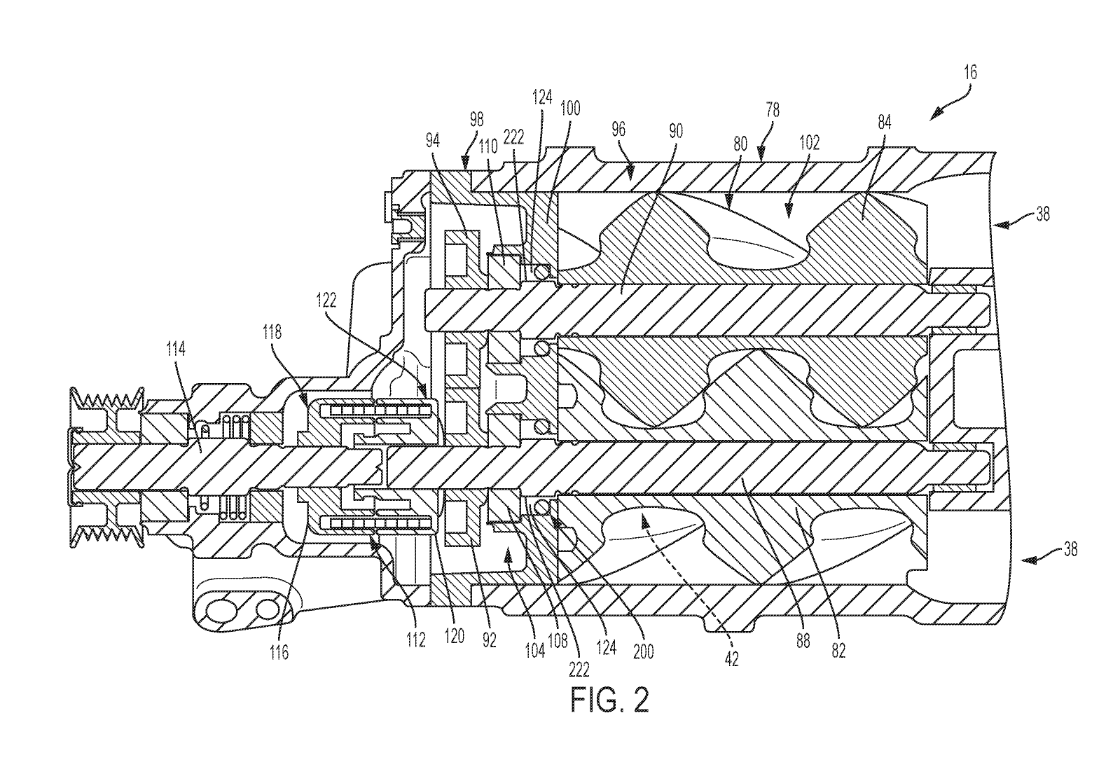

With reference to FIG. 2, additional features of the supercharger 16 will be described in greater detail. The supercharger 16 includes a housing 78 with a rotor assembly 80 having intermeshed rotors 82, 84, which transport the incoming compressed air from the supercharger inlet 38 to a supercharger outlet 42. The rotors 82, 84 are respectively coupled to the rotor shafts 88, 90 for rotation therewith, and timing gears 92, 94 are provided for transferring torque between the rotors 82, 84 and for ensuring that the rotors 82, 84 rotate at the same speed and do not interfere with one another. The rotor shaft 88 is mechanically coupled to a drive system such as the engine 12 (e.g., from the engine crankshaft), an electric motor/generator (not shown), or a combination thereof (e.g., hybrid system) to transfer torque to drive the intermeshed rotors 82, 84 for boosting the pressure of the air being supplied to the engine 12.

As illustrated in FIG. 2, the supercharger housing 78 defines a rotor case 96 and a gear case 98 separated by a wall 100. The rotor case 96 houses the rotors 82, 84 and at least partially defines a rotor cavity 102 for directing air between the supercharger inlet 38 and the outlet 42. The gear case 98 houses the timing gears 92, 94 and the shaft bearings 108, 110, and at least partially defines a bearing cavity 104 to retain lubricating oil for the timing gears 92, 94, the shaft bearings 108, 110, or other components. The first and second rotor shafts 88 and 90 are rotatably supported by the housing 78 at the first bearing 108 and the second bearing 110.

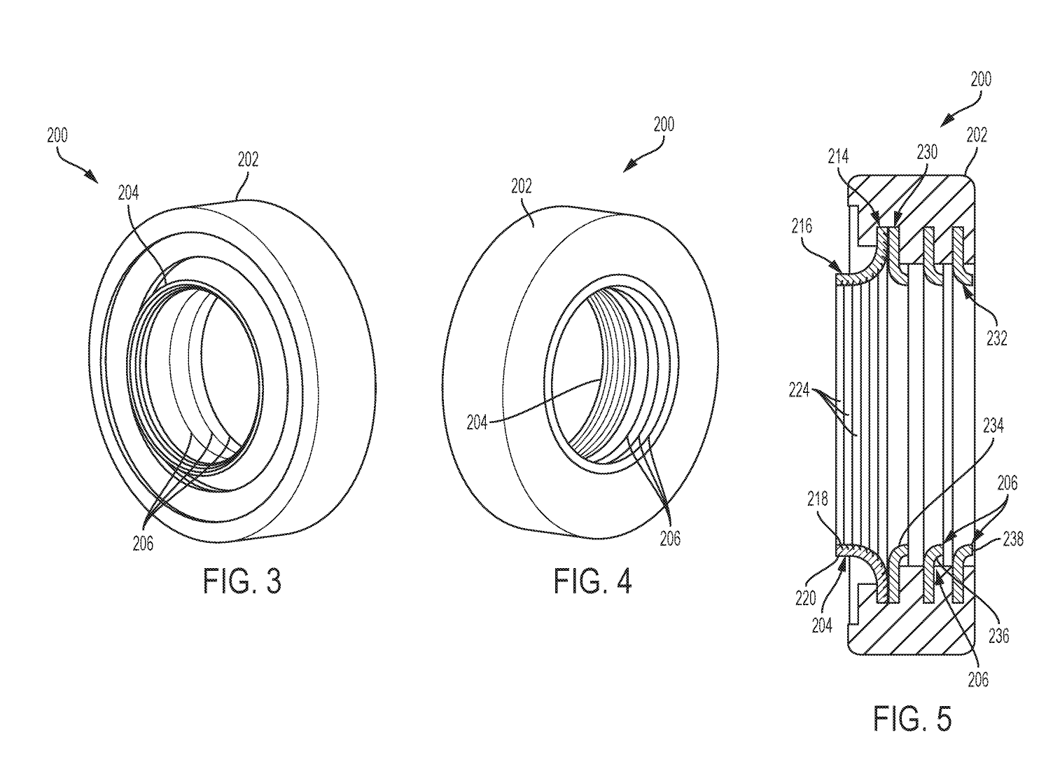

A coupling or isolator assembly 112 couples an input shaft 114 to the first rotor shaft 88. In one example, a first hub 116 couples the input shaft 114 to the isolator assembly 112 on a first end 118, and a second hub 120 couples the first rotor shaft 88 to the isolator assembly 112 on an opposite end 122. The timing gear 92 may be mounted on a forward end of the rotor shaft 88 and defines teeth (not shown) that are in meshed engagement with gear teeth (not shown) of the second timing gear 106 that may be mounted on the second rotor shaft 90. It will be appreciated in light of the disclosure that the isolator assembly 112 shown in FIG. 3 is exemplary and other isolators may be used to couple the input shaft 114 and the first rotor shaft 102.

In one configuration, positive torque is transmitted from the internal combustion engine 12 to the input shaft 114 by any suitable drive mechanisms, such as a belt and pulley drive system (not shown). Torque can be transmitted from the input shaft 114 to the rotor shaft assembly 80 through the isolator assembly 112, which provides torsional and axial damping and may further account for minor misalignment between the input shaft 114 and the first rotor shaft 88. When the engine 12 is driving the timing gears 92, 94 and the rotors 82, 84, such is considered to be transmission of positive torque. On the other hand, whenever the momentum of the rotors 82, 84 overruns the input from the input shaft 114, such is considered to be the transmission of negative torque.

In the illustrated example, the housing 78 further includes seal receiving cavities or bores 124, which are positioned intermediate the rotor cavity 102 and the bearing cavity 104. The seal receiving bores 124 are configured to receive rotor shaft seals 200, 300, 400 to fluidly separate and isolate the rotor cavity 102 and the bearing cavity 104. The high pressure rotor shaft seals 200, 300, 400 are disposed about the rotor shafts 88, 90 and are configured to seal the gear case 98 and can be shown to prevent pressurization of the bearing cavity 104 by the high pressure boost air supplied to the rotor cavity 102 from the turbocharger 14.

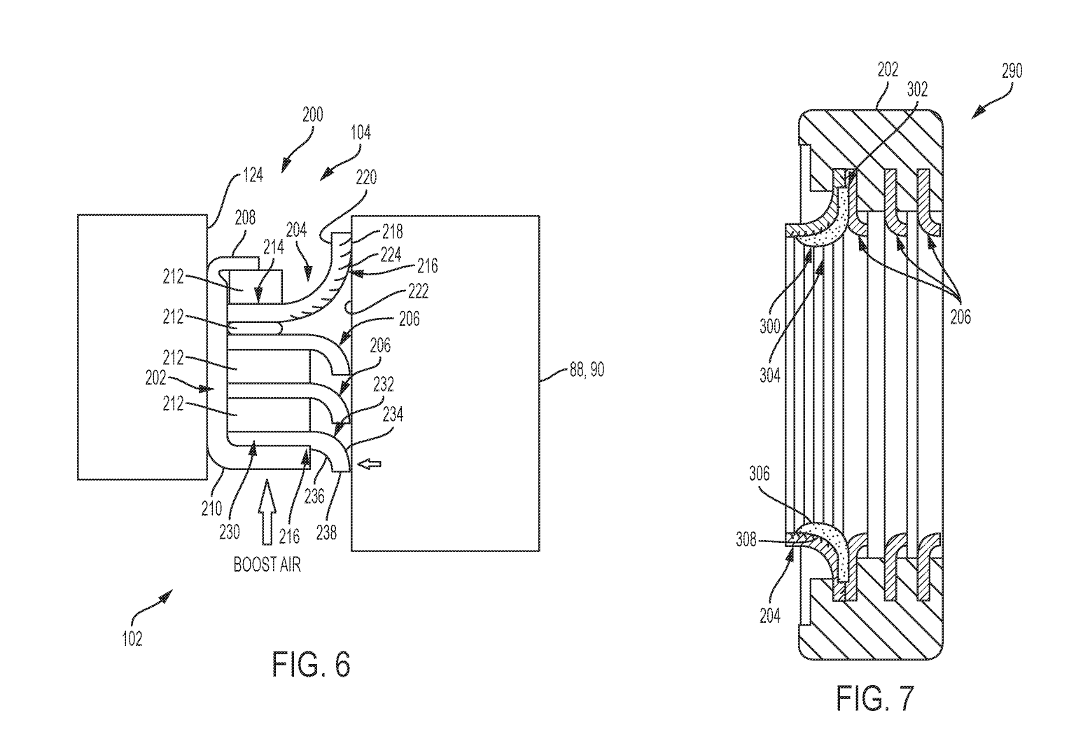

As illustrated in FIGS. 3-6, the high pressure rotor seals 200 generally include a cage 202, a primary, oil side lip 204, and one or more boost pressure blocking lips 206. The cage 202 can be fabricated from a rigid material (e.g., metal or plastic) and can include opposed first and second flanges 208 and 210 configured to secure the primary lip 204 and the boost pressure blocking lips 206 therebetween. Oil side lip 204 or blocking lips 206 or both may be fabricated from a flexible material such as PTFE. As illustrated in FIG. 6, a plurality of spacers 212 can be disposed between the primary lip 204, the boost pressure blocking lips 206, and the cage 202. One or more spacers 212 can be sized and configured to provide predefined spacing between adjacent lips 204, 206, between an adjacent lip 204 and flange 208, 210, or between an adjacent lip 206 and flange 208, 210.

In the present example, the primary lip 204 includes a proximal portion 214, a distal portion 216, a first side 218, and an opposite second side 220. The proximal portion 214 is disposed at least partially within the cage 202 between a pair of spacers 212. The distal portion 216 can extend outwardly from the proximal portion 214, and thus the cage 202, toward the rotor shaft 88 or 90. As illustrated in FIGS. 5 and 6, the distal portion 216 subsequently curves and extends toward the bearing cavity 104 of the supercharger 16. As shown, the distal portion 216 is curved along at least a portion and has a radius of curvature that may be determined by a desired primary lip thickness and desired hoop stress.

At least a portion of the distal portion first side 218 can contact and be in sealing arrangement with an outer surface 222 of the rotor shaft 88 or 90 (see FIG. 6). In the illustrated example, the distal portion first side 218 includes a plurality of hydrodynamic grooves 224 configured to pump oil across the seal 200, which can be shown to facilitate cooling the shaft/seal interface and removing debris from the seal. As such, the primary lip 204 can extend toward the bearing cavity 104 and can be shown to prevent oil from traveling from the bearing cavity 104 to the rotor cavity 102.

The boost pressure blocking lip 206 includes a proximal portion 230, a distal portion 232, a first side 234, and a second side 236. The proximal portion 230 can be disposed at least partially within the cage 202 between a pair of spacers 212 or between one spacer 212 and a portion of the cage 202 (e.g., flange 210). The distal portion 232 can extend outwardly from the proximal portion 230, and thus the cage 202, toward the rotor shaft 88 or 90. As illustrated in FIGS. 5 and 6, the distal portion 232 subsequently curves and extends toward the air side or the rotor cavity 102 of the supercharger 16. As shown, the distal portion 232 can be curved along at least a portion and has a radius of curvature that can be based on a combination of a thickness and desired hoop stress of the primary lip 204.

At least a portion of the distal portion first side 234 can contact and be in sealing arrangement with the rotor shaft outer surface 222. The boost pressure blocking lip 206 can extend toward the rotor cavity 102 and can be shown to prevent turbocharger high pressure boost air from entering the bearing cavity 104. As high pressure boost air from the turbocharger 14 enters the supercharger 16, a portion of the high pressure boost air can contact the distal portion second side 236 or an end 238 of the lip 206 or both, that can force the distal portion first side 234 further against the rotor shaft 88, 90 to maintain the seal therebetween. As shown in FIGS. 5 and 6, additional boost pressure blocking lips 206 may be disposed between the outermost blocking lip 206 and the primary lip 204 and can be shown to provide additional sealing or to function as a backup seal in the event of damage or wear to the outermost blocking lip 206. Although three boost pressure blocking lips 206 are illustrated, the high pressure rotor seals 200 may have any suitable number of lips 206 that enable the seal 200 to function as described herein. For example, the seal 200 may include one or four lips 206.

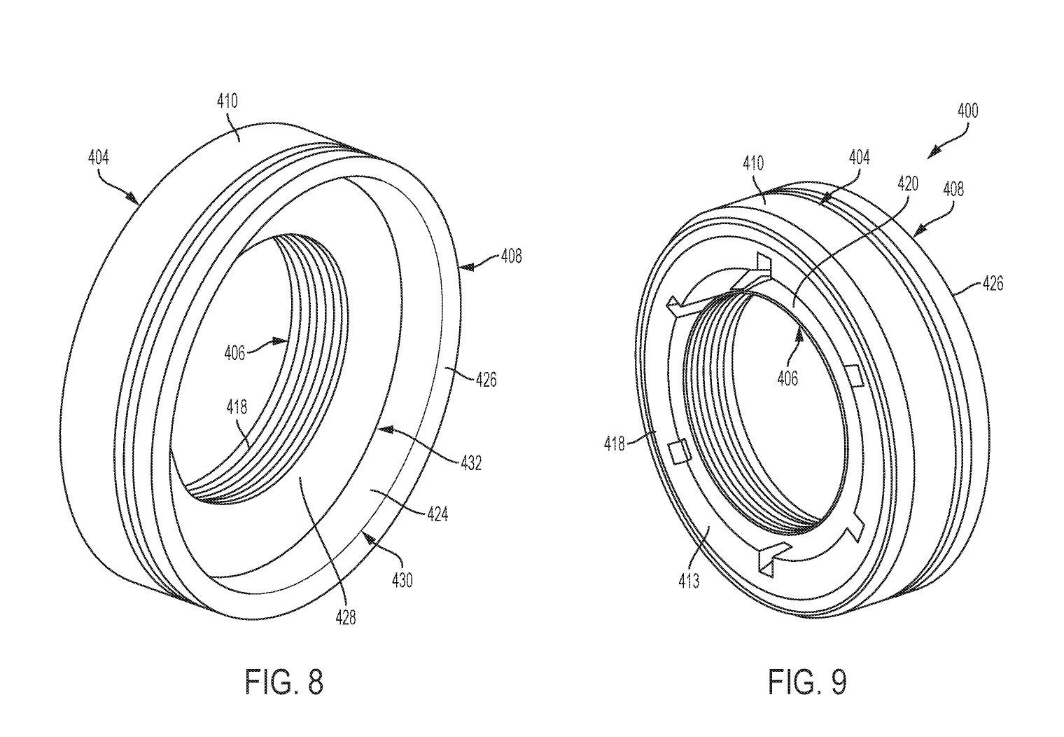

FIG. 7 illustrates a rotor seal 290 that can be an alternative example of the seal 200, except the seal 290 includes a backing plate 300. In the illustrated example, the backing plate 300 can be fabricated from a rigid material (e.g., metal) and can include a proximal portion 302, a distal portion 304, a first side 306, and a second side 308. As shown, the proximal portion 302 can be disposed at least partially within the cage 202 between the primary lip 204 and blocking lip 206. However, one or more spacers 212 may be used therebetween. The distal portion 304 can extend outwardly from the proximal portion 302, and thus the cage 202, toward the rotor shaft 88 or 90. As illustrated in FIG. 7, the distal portion 304 subsequently curves and extends toward the bearing cavity 104 of the supercharger 16. As shown, the distal portion 304 can be curved along at least a portion thereof. In one example, distal portion 304 can follow or generally follow the curvature of the primary lip 204. The backing plate 300 can be configured to provide structural support to the primary lip 204 and can be shown to prevent the primary lip 204 from being crushed under excessive boost pressure.

Described herein are systems and structures for sealing configurations for boost systems, particularly when a supercharger is disposed downstream of a turbocharger and receives high boost pressure therefrom. The system includes high pressure rotor seals that include one or more boost pressure blocking lips. The boost pressure blocking lips are in sealing contact with a rotor shaft and are further forced against rotor shaft under high boost pressure conditions to maintain a seal therebetween. The high pressure rotor seals may include a backing plate configured to provide structural support to a primary, oil-side lip. As such, the high pressure rotor seals prevent crushing of the rotor seal under excessive boost pressure from an upstream boost system.

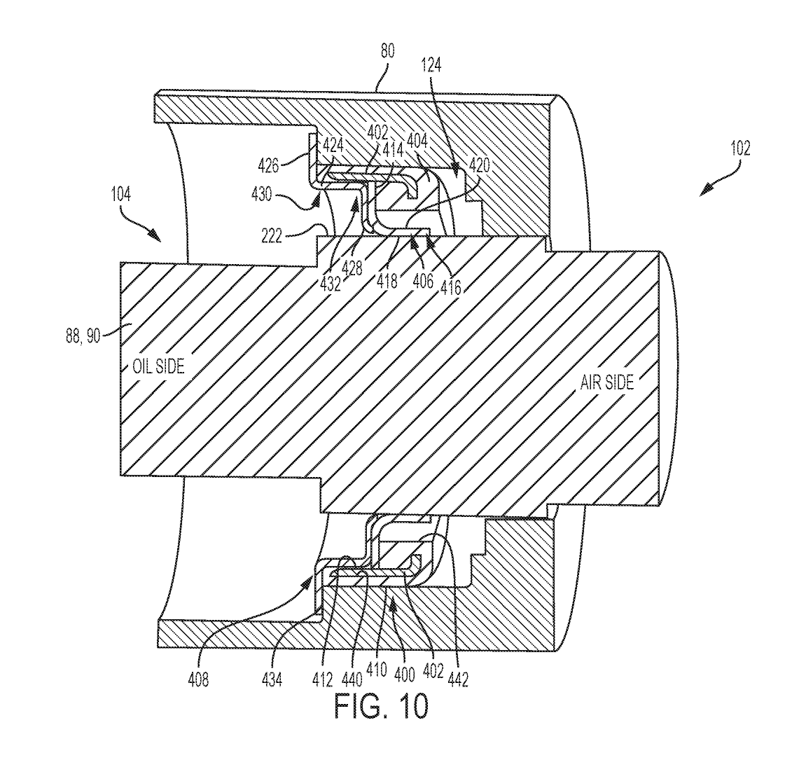

FIGS. 8-10 illustrate another example high pressure rotor seal 400 that generally includes a cage 402, a body 404, a primary oil side lip 406, and a support plate 408. The cage 402 can be fabricated from a rigid material (e.g., metal or plastic), and the body 404 can be disposed about the cage 402 such as by overmolding. The body 404 can define an outer surface or 410, a first inner surface 440, and a second inner surface 442. In one embodiment, the body 404 can be fabricated from an elastic material such as rubber, and the primary lip 406 can be fabricated from a flexible material such as PTFE. The support plate 408 can be fabricated from a rigid material (e.g., metal or plastic) and may be pressed into the seal 400 and/or the housing 80, as described herein in more detail.

In the present example, the primary lip 406 can include a proximal portion 414, a distal portion 416, a first side 418, and an opposite second side 420. The proximal portion 414 can be clamped into position, for example, by the cage 402 or metal rings. The distal portion 416 can extend outwardly from the proximal portion 414, and thus the cage 402, toward the rotor shaft 88 or 90. As illustrated in FIG. 10, the distal portion 416 subsequently curves and extends toward the air side or the rotor cavity 102 of the supercharger 16.

At least a portion of the distal portion first side 418 can contact and be in sealing arrangement with an outer surface 222 of the rotor shaft 88 or 90 (see FIG. 10). Although not shown, the distal portion first side 418 may include a plurality of hydrodynamic grooves configured to pump oil across the seal 400, which facilitates cooling the shaft/seal interface and removing debris from the seal. As such, the primary lip 406 can extend toward the rotor cavity 102 and can be shown to prevent oil from traveling from the bearing cavity 104 to the rotor cavity 102.

The support plate 408 can be generally annular and can include an annular or generally annular rim 424, a first outwardly extending flange 426, and a second inwardly extending flange 428. The rim 424 can include a first end 430 and an opposite second end 432. The flange 426 can be coupled to the rim first end 430 and extend radially outward of the rim 424, and the flange 428 can be coupled to the rim second end 432 and extend radially inward of the rim 424. The flange 428 may be shaped to substantially follow at least a portion of the shape of the primary lip 406, and the flange 428 can be spaced apart from the rotor shaft outer surface 222 to define a gap therebetween that enables lubricating oil to flow to the primary lip 406.

In one example, the support plate 408 can be inserted or pressed into a seal inner diameter 412, and the high pressure rotor seal 400 can be subsequently inserted into the seal receiving bore 124. In another example, the high pressure rotor seal 400 can be inserted into the seal receiving bore 124 and the support plate 408 can be subsequently inserted or pressed into the seal inner diameter 412.

In the assembled position, as illustrated in FIGS. 3-5, the rim 424 can be disposed against or in proximity to the seal inner diameter 412, the outwardly extending flange 426 can be disposed against or in proximity to a shoulder 434 of the housing 80 (see FIG. 10), and the inwardly extending flange 428 can be disposed against or in proximity to the primary lip 406. As such, the support plate 408 can be disposed at least partially within the seal body 404 to provide structural support to the seal 400, and thus the primary lip 406, to prevent the primary lip 406 or other portions of the seal 400 from being crushed under excessive boost pressure.

Described herein are systems and structures for sealing configurations for boost systems, particularly when a supercharger is disposed downstream of a turbocharger and receives high boost pressure therefrom. The system includes high pressure rotor seals and a rigid guide plate disposed within at least a portion of the high pressure rotor seal. The support plate is configured to provide structural support and increase radial rigidity of components of the seal such as the primary lip, which extends toward the air side of the supercharger. As such, the high pressure rotor seals prevent crushing of the rotor seal under excessive boost pressure from an upstream boost system.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

1. A high pressure rotor seal for a supercharger that receives and/or generates high pressure boost air and contains gear lubrication, the rotor seal comprising:
a primary lip configured to contact a rotor shaft of the supercharger and be in contact with the gear lubrication; and
at least one blocking lip configured to contact the rotor shaft of the supercharger, the at least one blocking lip configured to maintain a seal against the rotor shaft when the high pressure boost air acts thereon.

2. The rotor seal of claim 1, wherein the at least one blocking lip includes two blocking lips.

3. The rotor seal of claim 1, wherein the at least one blocking lip includes three blocking lips.

4. The rotor seal of claim 1, further comprising a backing plate disposed adjacent the primary lip, the backing plate configured to provide structural support to the primary lip and prevent the primary lip from being crushed under excessive boost pressure.

5. The rotor seal of claim 4, wherein the backing plate is curved.

6. The rotor seal of claim 5, wherein the curved backing plate generally follows a curvature of the primary lip.

7. The rotor seal of claim 1, further comprising a cage, wherein the primary lip and the at least one blocking lip are at least partially secured within the cage.

8. The rotor seal of claim 7, wherein the cage includes a first flange and a second flange, at least a portion of the primary lip and the at least one blocking lip disposed between the first and second flanges.

9. The rotor seal of claim 8, wherein the primary lip includes a proximal portion disposed between the first and second flanges, and a distal portion extending toward the rotor shaft and a bearing cavity of the supercharger.

10. The rotor seal of claim 9, wherein each blocking lip includes a proximal portion disposed between the first and second flanges, and a distal portion extending toward the rotor shaft and a rotor cavity of the supercharger.

11. The rotor seal of claim 10, further comprising:
a spacer disposed between the proximal portion of the primary lip and the proximal portion the at least one blocking lip; and
hydrodynamic grooves formed on a first side of the primary lip, the hydrodynamic grooves configured to pump oil across the rotor seal.

12. A supercharger that receives and/or generates high pressure boost air and contains gear lubrication, the supercharger comprising:
a housing;
a rotor coupled to a rotor shaft rotatably supported in the housing; and
a high pressure rotor seal disposed about the rotor shaft, the high pressure rotor seal having:
a primary lip configured to contact the rotor shaft and be exposed to the gear lubrication; and
at least one boost pressure blocking lip configured to contact the rotor shaft and maintain a seal against the rotor shaft when the high pressure boost air acts thereon.

13. The supercharger of claim 12, further comprising an inlet port formed in a forward end of the housing, the inlet port configured to receive at least one of air, an air-fuel mixture, and the high pressure boost air.

14. The supercharger of claim 12, wherein the at least one blocking lip includes two blocking lips.

15. The supercharger of claim 12, wherein the at least one blocking lip includes three blocking lips.

16. The supercharger of claim 12, wherein the high pressure rotor seal further comprising a backing plate disposed adjacent the primary lip, the backing plate configured to provide structural support to the primary lip and prevent the primary lip from being crushed under excessive boost pressure.

17. The supercharger of claim 16, wherein the backing plate is curved and generally follows a curvature of the primary lip.

18. The supercharger of claim 12, wherein the high pressure rotor seal further comprising a cage, wherein the primary lip and the at least one blocking lip are at least partially secured within the cage.

19. The supercharger of claim 18, wherein the cage includes a first flange and a second flange, at least a portion of the primary lip and the at least one blocking lip disposed between the first and second flanges.

20. The supercharger of claim 19, wherein the primary lip includes a proximal portion disposed between the first and second flanges, and a distal portion extending toward the rotor shaft and a bearing cavity of the supercharger;
wherein each blocking lip includes a proximal portion disposed between the first and second flanges, and a distal portion extending toward the rotor shaft and a rotor cavity of the supercharger; and
a spacer is disposed between the proximal portion of the primary lip and the proximal portion the at least one blocking lip.

21-40. (canceled)
